(19) United States
(12) Patent Application Publication
(10) Pub. No.: US 2009/0066055 A1
(43) Pub. Date: Mar. 12, 2009

(54) Bike belt - power stroke harness

(76) Inventor: Kenneth G. Lay, Edgartown, MA (US)

Correspondence Address: BURNS & LEVINSON, LLP, 125 SUMMER STREET, BOSTON, MA, 02110, US

(21) Appl. No.: 12/231,462

(22) Filed: Sep. 3, 2008

Related U.S. Application Data
(60) Provisional application No. 60/967,465, filed on Sep. 5, 2007.

(51) Int. Cl. A62B 35/00; B62J 99/00

(52) U.S. Cl. 280/290

(57) ABSTRACT

A bicycle rider waist harness and attaching means comprising a dual acting, isokinetic, combination chain and bungee arrangement connected to a bicycle frame for the to provide an adjustable means of attachment for a waist harness of a bicycle rider. The combination bungee-chain arrangement has the capacity to be fixedly attached to a bicycle frame and also is capable of being readily relocated to a more mechanically efficient location by means of a U-bolt assembly or similar movable attaching means. The open linked chain also provides an attaching means for a stretchable bungee cord having hooks or other like attaching connectors to allow for quick attachment and adjustment to the chain. The bungee cord is so attached to the open linked base chain such that a small amount of resistance is put on the waist harness hook to offer the bicycle rider a guiding line to the connecting point on the frame of the bike of the open linked chain assembly The sliding hook may be readily attached and removed from the base chain as necessary; it is equipped with a quick release escape mechanism to be readily disconnected from the base chain at will.

### REFERENCE TO RELATED APPLICATION

This application claims priority of provisional application Ser. No. 60/967,465, filed Sep. 5, 2007.

### BACKGROUND OF THE INVENTION

This invention relates generally to street/road/terrain bicycles and stationary exercise bikes and more particularly, to the method of power transmission generated by the rider as he or she pedals.

Those experienced in the fields of exercise and bicycling are adept in the two general styles of bicycle frames. The first or conventional is the traditional design of the bicycle where a rider assumes a more upright or vertical position (racing bikes included). The second and more current design is one that is referred to as a recumbent design. Both designs have distinct advantages and disadvantages, and as a matter of style riders make their own decisions as to which they prefer.

However, it is this inventor's observation that both have distinct mechanical flaws, which actually undermine the amount of force which can be generated by the rider at any time. A closer analogy will dramatically illustrate that both bicycle designs are inefficient with respect to power transmission. A simple analogy of such inefficiency would be, a person attempting to use a screwdriver with a bent shaft. The screwdriver's efficiency is greatly diminished. In fact it actually requires the user work harder and therefore waste energy while compensating for the bent shaft.

For the sake of discussion each bicycle type, the upright versus the recumbent can either be classified as either a one position or a two position bicycle.

The recumbent is virtually a one positioned bicycle. The user installs himself onto the bicycle in a “recumbent position”. Once in this position, the body's mass is almost fully supported by the frame of the bicycle. It is important to note here that the body's mass is no longer contributing to the power generation. This is critical because the body's mass given the correct mechanical advantage has the potential to contribute gigantic force loads onto the power stroke of the pedals. The primary advantage of the recumbent bicycle is to brace the lower back to provide a stable base of support or fulcrum, which increases the potential force load generated during the “power stroke” of the pedaling cycle.

The conventional bike or upright bicycle is a two position bicycle. One position is seated and the other position is standing or sometimes more specifically partially standing. The rider then has the option to utilize his body mass as increased demand for power is needed, certainly when peddling up hills etc. It is obvious to the trained observer that there exists an inherent flaw with the “upright bicycle”, that is, the lower back of the rider is unsupported. This fact alone is what precipitated the design of the recumbent bicycle.

The fact of the matter is that there are flaws in both one and two position bicycles.

Simply put the flaw with regards to the one position or “recumbent bike”, as mentioned above, is its inability to allow the rider to induce his personal mass into the cycle stroke. Another, more subtle flaw is the fact that while the hips are held secure and immobile this actually interferes with one's ability to create momentum or more specifically inertia through the pelvic region that would otherwise increase power during peak demands of the cycle stroke. (A further analogy of this position is; If one were to, place a battering ram directly against a door and simply apply a force to the battering ram without momentum, the door would remain impenetrable. In reality it is inertia and momentum that breaks the door down.) It is anticipated by this inventor that a solution to this problem would be a sliding seat arrangement to enable the user to “put his hips into” the power stroke. That is not the object of this invention and the intricate mechanical components necessary to achieve this end for a recumbent bicycle would most likely be to cost prohibitive.

The flaws with the “two position bicycle” or upright bicycle are a little more subtle. First, we must examine what happens during the cycle stroke as the rider is seated. By using a piece of wax paper we can demonstrate how it becomes acutely apparent that the amount of force generated upon the pedals by the rider is actually directly proportional to coefficient of friction between the rider's buttocks and the bicycle seat. If we simply attach a piece of wax paper on top of the bicycle seat, (To make this example even more dramatic, we could attach another piece of wax paper to the bottom of the rider's buttocks.) we would then discover that as the peddling requirements become more intense, the rider's buttocks would slide right off the seat. Therefore keeping this in mind, this fact will reveal that the rider subconsciously must always be holding his or her buttock against the seat for power transmission to be facilitated.

This is very significant because the upright bicycle rider is always faced with a decision, unlike the recombinant rider, “should I stand or should I sit”. With the bicycle harness one has a movable and stable support base for the lower back acting as a fulcrum for the legs, which is effective in both the seated in standing positions. This in fact simplifies the decision making process. With the harness in place, even if a rider that had a piece of wax paper on the seat would slide backwards also but only to the point that the harness limits that movement. In summary, when viewing a seated bike rider on a conventional bike, while approaching a slight incline the rider is faced with the decision to either remain seated or stand. Too often, when faced with this decision, for some unknown reason, the rider usually remains seated which by some measure gives credence to the term, “holding oneself back”.

Conversely, a rider who is standing while pedaling, has the ability to apply his center of mass downwards on to the pedals. This would ensure that his center of mass would be applied to the power stroke of the pedaling cycle. To the unskilled eye this would seem adequate. However, if we restrict the location of the center of mass in a vertical relationship relative to the pedals we find once again that has the harness locks the lower back in to a fixed position. This action creates a fulcrum for the legs giving them the added ability to drive more force onto the pedals than just the mass of the body alone. It is anticipated that the mechanical connection between the rider and the bicycle could likely increase the force potential by as much as 30%.

### SUMMARY OF THE INVENTION

Having established that both current bicycle styles, the upright and the recumbent, fail to incorporate the body's central mass effectively when peddling, the challenge is to devise a means to utilize this central mass to its fullest potential.

It is an object of this invention to provide the bicycle rider with a stable yet mobile base of support for one's central mass or lumbar area of the lower back. By doing so, said harness device acts as a floating fulcrum to be utilized in the conventional up right or racing-type bicycle. Because it moves with the rider it can be effective in both the seated and standing positions.

A further object of this invention is to provide the rider with an effective fulcrum for the legs, such that he or she gains the ability to generate maximum force load potential during the power stroke phase of the pedaling process.

Said device is so designed to be portable and can be attached on stationary bicycles for increased muscular benefits, as well.

A further object of this invention is to provide the bicycle rider with a bungee-type guidance system to continually direct the rider's attention to the exact point of attachment on the frame of the attaching means. This information is critical, because the rider will always know exactly where to position his body to generate the maximum force load possible without confusion or error.

A further object of said bungee component is to act as part of a breakaway release assembly.

A further object of this invention is to give the bicycle rider a different mechanical connection to the bicycle. This “mechanical connection” to the frame of the bicycle aids the rider during cornering. Because the torso and upper body are now directly connected to the frame, the rider has the added ability to put “more lean” into the turns. Once the body and the bike act as one solid unit, the entire weight and length of the body gain a greater mechanical advantage while leaning into the turns. Conversely, without said harness the upper body actually assumes a more vertical position, as the rider travels through a turn. However, by using the harness the rider utilizes centripital force to overcome the centrifugal force of the turn.

A further object of said harness device with regards to racing bike enthusiasts is one that involves visualizing how an individual rides a racehorse. The race was rider always appears to be levitating above the racehorse itself. His buttocks are never in contact with the seat of the horse. It is this inventor's observation that the ideal racing bike position would mirror the racehorse rider's posture. The slight variation is that the harness limits the height that the lower back can be held above the seat. Of course, as discussed before, this provides the bicycle rider with a fulcrum for the legs to generate even greater force loads onto the pedals than without the harness.

The objects set forth above, as well as, further and other objects and advantages of the present invention are achieved by the embodiments of the invention described herein below.

The present invention is comprised of a means of attaching a chain or similar adjustable assembly to the frame of the bicycle.

The frame attaching hardware may be removed, repositioned and reattached to the frame as necessary.

The opposite end of the chain or adjustable belt assembly is attached to an adjustable cushioned waist harness, which is then attached to the rider.

A further embodiment of the chain component or adjustable belt assembly is a system of holes or eyelet's to allow for a second bungee type strap assembly to be secured to the first chain component. The bungee type strap assembly is to serve as a guidance system as well as part of a quick release assembly.

The waist harness assembly is equipped with an eyelet or ring arrangement to be connected to the base chain/strap assembly.

The waist harness is comprised of a dual belt arrangement. One, the inner belt, is attached to and adjusted by said bicycle rider resembling an ordinary belt for one's trousers.

A second outer belt is adjustable and equipped with a sliding steel ring or equivalent loop attached to said second belt for the purpose of attachment to the base chain member.

The loop of the second belt arrangement is connected to the base chain assembly by means of the removable pull pin.

The pull pin alternatively may be attached to the eyelets of the second outer belt assembly by means of a quick release lever-type jaw opening mechanism.

Other objects, features and advantages will be apparent from the following detailed description of preferred embodiments taken in conjunction with the accompanying drawings in which:

### BRIEF DESCRIPTION OF DRAWINGS

FIGS. 1-4 represent four views the power stroke harness arrangement;

FIG. 1, illustrates a rider and harness complete, less the bungee hook arrangement; FIG. 2, illustrates the base chain hand frame attaching member; FIG. 3, illustrates the dual belt harness arrangement; and FIG. 4 illustrates to complete assembly, along with the bungee hook arrangement.

FIG. 5 shows unlatched position of a preferred locking/quick disconnect sub-assembly in side or top view; and FIGS. 6 and 7 show components of one of the portions of subassembly in isometric view.

### DETAILED DESCRIPTION OF PREFERRED EMBODIMENTS

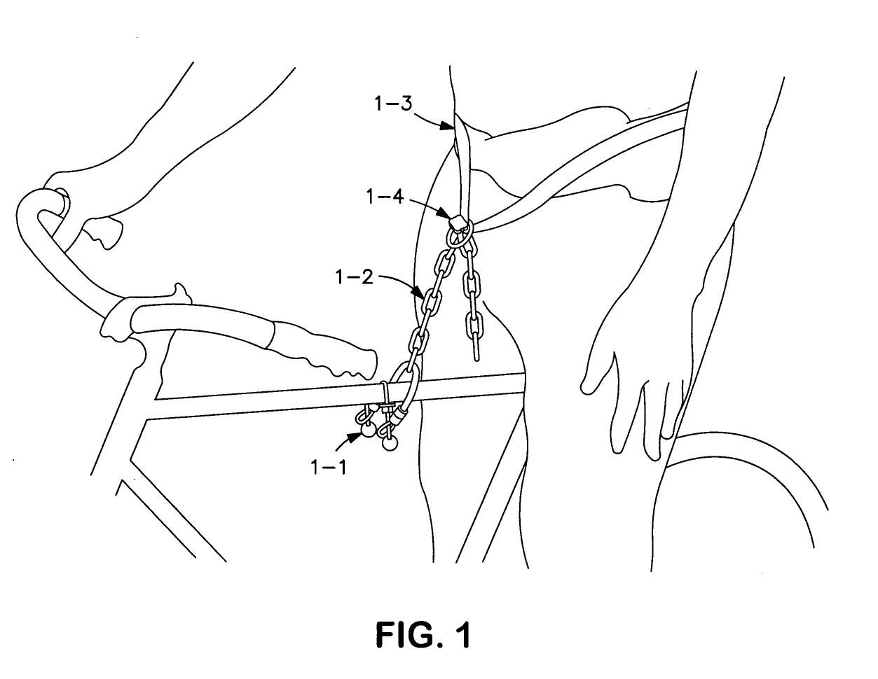

Reference is made to FIG. 1 of the drawings, which pictorially represents the bicycle rider demonstrating utilizing the power stroke harness and chained to the bicycle frame. Item 1-1 is a U-bolt attachment means for anchoring the base chain. Item 1-2 illustrates the base chain. Item 1-3 is the dual belt arrangement for the harness. Item 1-4 is the quick release pin and socket, e.g. to connect the base chain to the power stroke harness assembly.

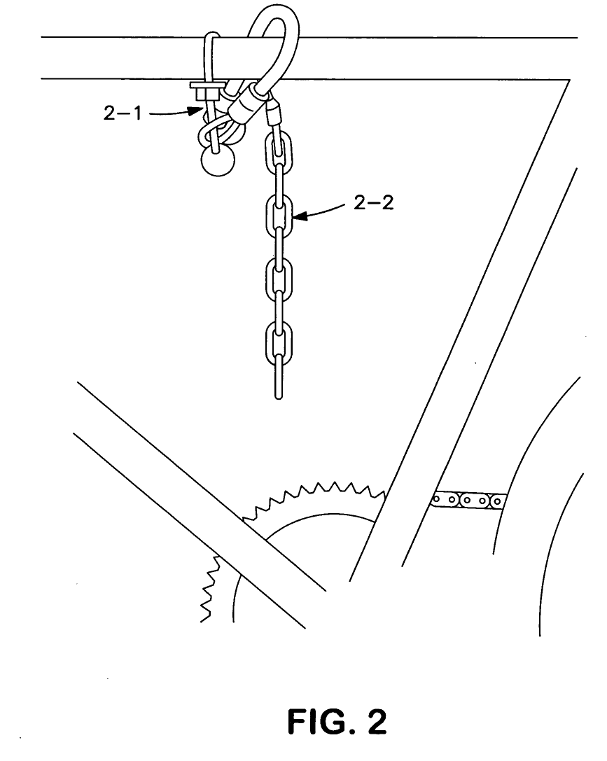

FIG. 2 demonstrates the method of attachment of the base chain to the bicycle frame. Item 2-1 is the U-bolt anchoring system. Item 2-2 illustrates the base chain assembly.

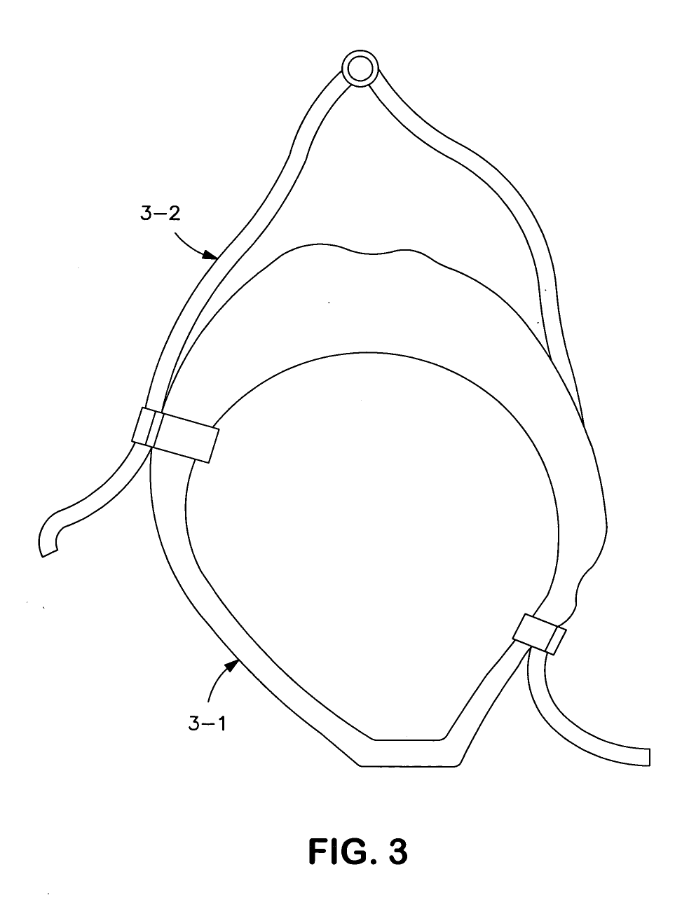

FIG. 3, shows the dual belt arrangement of the harness assembly. Item 3-1 illustrates the inner loop harness, which is attached directly to the rider. Item 3-2 is the outer loop arrangement with the sliding steel ring for attachment to the said base chain.

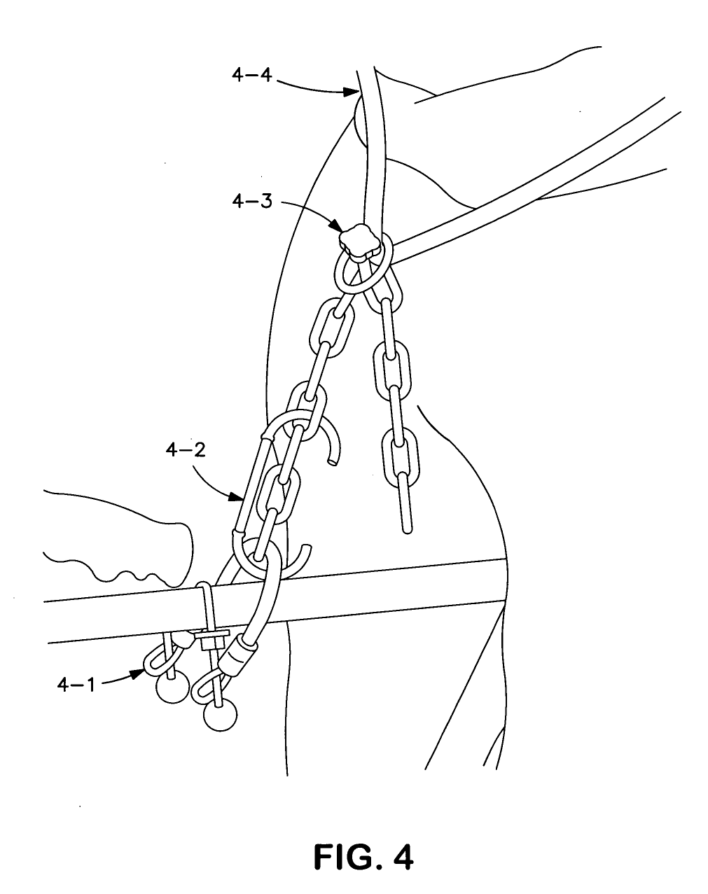

FIG. 4, shows the entire power stroke harness assembly and attachment means. Item 4-1 is the base chain anchoring components. Item 4-2 is the bungee hook arrangement. Item 4-3 is the pull pin means for attaching the harness to the base chain. Item 4-4—shows the tool harness belt arrangement.

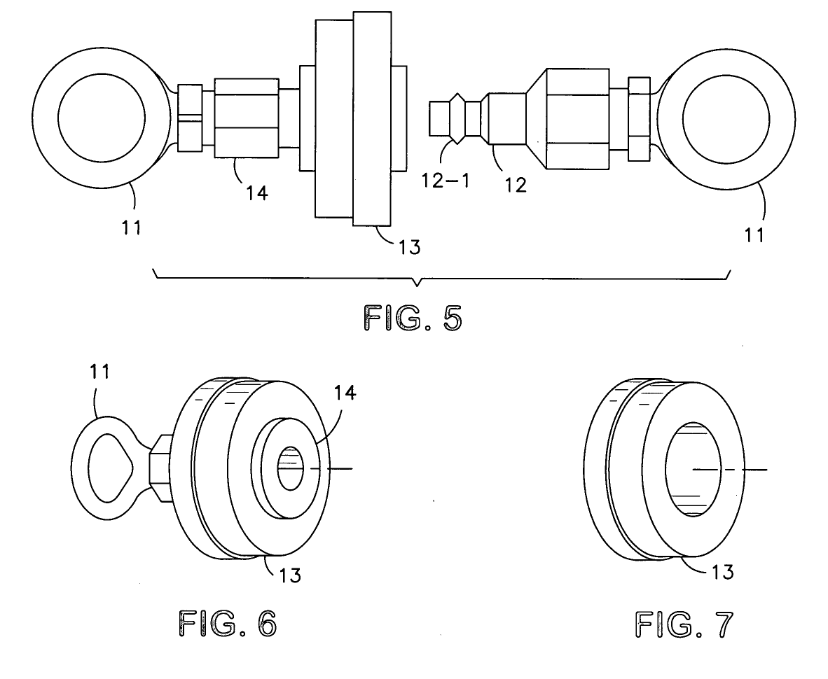

FIGS. 5-7 show a quick release mechanism for releasing the bike belt from the frame. It is of a form similar to air hose quick release fittings as a subassembly of the overall system including parts 11 (chain attachment ring), 12 (male component of air hose type fitting with a locking flange 12-1), and 14 (female component of air hose fitting). Item 14 has internal ball bearings that yield (into a recess) as flange 12-1 passes under them and spreads back to lock. However, this subassembly also involves a leverage ring 13 which is permanently attached to the female portion of the air hose type fitting and can be grasped by one hand of the rider to pull back towards the rider to overcome restraint of the bearings and effectively pull them past the flange 12-1 to decouple members 12, 14. The significance of the leverage ring 13 is that it both allows the user to tactily identify it without visual notice and it provides further leverage to release the rider instantly from the anchoring chair portion of the bike belt attached to the bicycle frame in an emergency situation.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

What is claimed is:

1. A movable and adjustable harness for a bicycle rider to act as a support lower back fulcrum for the legs when pedaling comprising:
A) a harness removably attachable to the bicycle frame by means of a an attaching arrangement to anchor and allow for repositioning for the restraining chain and said attaching arrangement;
B) the attaching arrangement including a first restraining chain is comprised of opened loops, constructed and arranged for receiving a second restraining component comprised of a resilient linkage means for receiving;
C) the resilient linkage means linked into the opened loops of the chain to add a constant yet minimal amount of resistance between the bicycle frame and the rider;
D) the chain being attached to the rider harness by means of an arrangement for quick release;
E) the harness comprising a dual belt arrangement the first, an inner belt, being adjustable and a secureable around the waist of the rider in the same manner as a standard belt; the second, an outer belt being also adjustable, but containing a sliding metal ring, which is attachable to the restraining base chain; and
F) said resilient linkage means being so constructed and arranged as to direct the rider's attention to the location of the anchor point of the base chain, where it connects on the bicycle frame.

2. The apparatus of claim 1 constructed and arranged to provide a combination resistance mechanism and a locking mechanism harnessing the rider's lower back and utilizing the rider's entire central mass during this pedaling cycle.

3. The apparatus of claim 1 wherein the quick release arrangement is of a pull pin type.

4. The apparatus of claim 1 wherein the quick release arrangement is a spring loaded lever arrangement.

5. The apparatus of claim 1 wherein the resilient linkage means comprises a bungee cord and hook.
